(19) United States
(12) Patent Application Publication
(10) Pub. No.: US 2013/0264163 A1
(43) Pub. Date: Oct. 10, 2013

(54) PANTOGRAPH MOUNTING STRUCTURE

(71) Applicants: Ram S. Mishra, Chennai (IN); Mary J. Trumper, Sullivan, IL (US); Varun S., Chennai (IN); Althaf Umar Farooq, Ami (IN)

(72) Inventors: Ram S. Mishra, Chennai (IN); Mary J. Trumper, Sullivan, IL (US); Varun S., Chennai (IN); Althaf Umar Farooq, Ami (IN)

(73) Assignee: Caterpillar Inc., Peoria, IL (US)

(21) Appl. No.: 13/443,439

(22) Filed: Apr. 10, 2012

(51) Int. Cl. B60L 5/24; B23P 11/00

(52) U.S. Cl. 191/65; 29/525.01

(57) ABSTRACT

A mounting structure for one or more pantographs is provided. The mounting structure comprises a bottom support structure, a mid support structure, and a top platform. The bottom support structure includes a pair of primary front legs. The mid support structure includes a pair of secondary front legs coupled to the pair of primary front legs. The mid support structure further includes a pair of angled rear legs rigidly connected to the pair of secondary front legs by a deck. The pair of secondary front legs extends above the deck. The mid support structure further includes a first and second pair of front and side extended support arms rigidly connected to a top portion of the pair of secondary front legs. The top platform is coupled to the mid support structure and is configured to mount the one or more pantographs.

### TECHNICAL FIELD

The present disclosure relates to a mounting structure, and more particularly to the mounting structure for one or more pantographs.

### BACKGROUND

Mounting structures are provided on machines in order to mount pantographs on the machine. The mounted pantograph facilitates in tapping electricity from an overhead electric line in order to power the machine. German Patent Number DE10256705 relates to a non-rail vehicle, such as a truck, used in open cast mining and having a pantograph. The pantograph is provided to supply power to the vehicle from a two pole overhead line. A sensor is also provided for determining the position of the pantograph relative to the overhead line. The sensor is connected to a display unit that can be seen by the driver and it shows the position of the pantograph. Furthermore, the sensor is connected to a control unit for the automatic steering of the vehicle.

### SUMMARY OF THE DISCLOSURE

In one aspect, the present disclosure provides a mounting structure for one or more pantographs. The mounting structure comprises a bottom support structure, a mid support structure, and a top platform. The bottom support structure includes a pair of primary front legs of a first length. The mid support structure includes a pair of secondary front legs of a second length. The pair of secondary front legs is coupled to the pair of primary front legs. The mid support structure further includes a pair of angled rear legs of a third length. The pair of angled rear legs is rigidly connected with the pair of secondary front legs by a deck. The second length is greater than the third length such that the pair of secondary front legs extend above the deck. A first and second pair of front and side extended support arms are rigidly connected to a top portion of the pair of secondary front legs. The top platform is coupled to the mid support structure and is configured to mount the one or more pantographs.

In another aspect, the disclosure provides a method for assembling a mounting structure. The method couples a bottom support structure to a pair of front mount elements. The bottom support structure includes a pair of primary front legs of a first length. The method couples a mid support structure to the bottom support structure and a pair of rear mount elements. The mid support structure includes a pair of secondary front legs of a second length. The pair of secondary front legs coupled to the pair of primary front legs. A pair of angled rear legs of a third length is rigidly connected to the pair of secondary front legs by a deck. The second length is greater than the third length such that the pair of secondary front legs extend above the deck. A first and second pair of front and side extended support arms is rigidly connected to a top portion of the pair of secondary front legs. Subsequently, the method couples a top platform assembled with one or more pantographs to the mid support structure.

Other features and aspects of this disclosure will be apparent from the following description and the accompanying drawings.

### BRIEF DESCRIPTION OF THE DRAWINGS

FIG. 1 is a side view of a front end of an exemplary machine having a mounting structure for one or more pantographs, according to one embodiment of the disclosure;

FIG. 2 is an assembled view of the mounting structure;

FIG. 3 is a diagrammatic view of a bottom support structure;

FIG. 4 is a diagrammatic view of a mid support structure;

FIG. 5 is a diagrammatic view of a top platform;

FIG. 6 is an assembled view of an alternate mounting structure; and

FIG. 7 is a method for assembling the mounting structure.

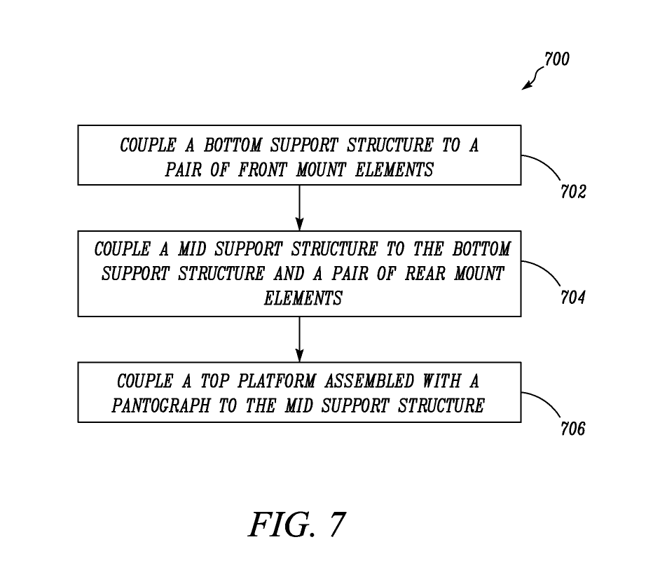

### DETAILED DESCRIPTION

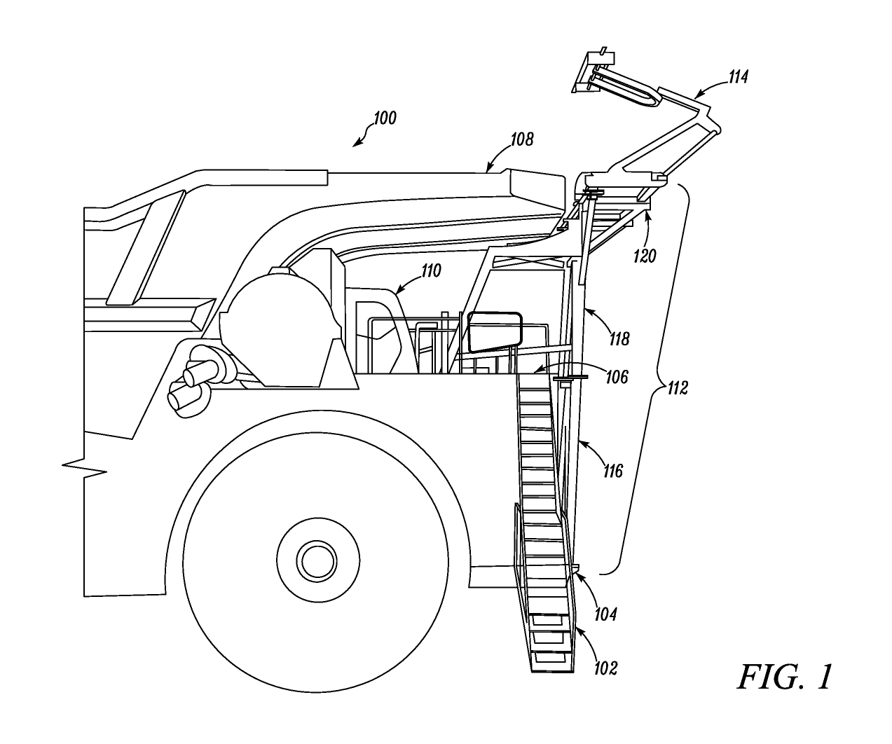

FIG. 1 shows a side view of a front end of an exemplary machine 100. The machine 100 may be a tracked or a wheeled vehicle, for example, but not limited to, heavy locomotives, trains, trams, trucks, and the like. In one embodiment, as shown in FIG. 1, the machine 100 may embody a mining truck which may be used for carrying a load such as ore extracted from the earth.

Further, the machine 100 includes an engine (not shown), a stairway 102, a bumper 104, a frame 106, a canopy 108, and an operator cabin 110. The engine may be a fuel based prime mover to power the machine 100 by combustion of natural resources, such as gasoline, other petroleum products or liquid natural gas. Moreover, the engine may be a petrol engine, diesel engine, or any other kind of engine utilizing combustion of fuel for generation of power.

As shown in FIG. 1, the operator cabin 110 may be provided on the frame 106 of the machine 100. The canopy 108 may extend over the frame 106 of the machine 100. An extended length of the canopy 108 may protect an operator from falling debris. A mounting structure 112 may be mounted on the machine 100. The mounting structure 112 may be used to mount one or more pantographs 114, in order to tap electricity from overhead wires (not shown in figure) to power or retard the machine 100. It should be understood that although a single pantograph 114 is visible in FIG. 1, there may be typically two pantographs 114 assembled on the mounting structure 112. The mounting structure 112 is mounted on the bumper 104 and the frame 106 of the machine 100. The mounting structure 112 is a modular structure including a bottom support structure 116, a mid support structure 118, and a top platform 120.

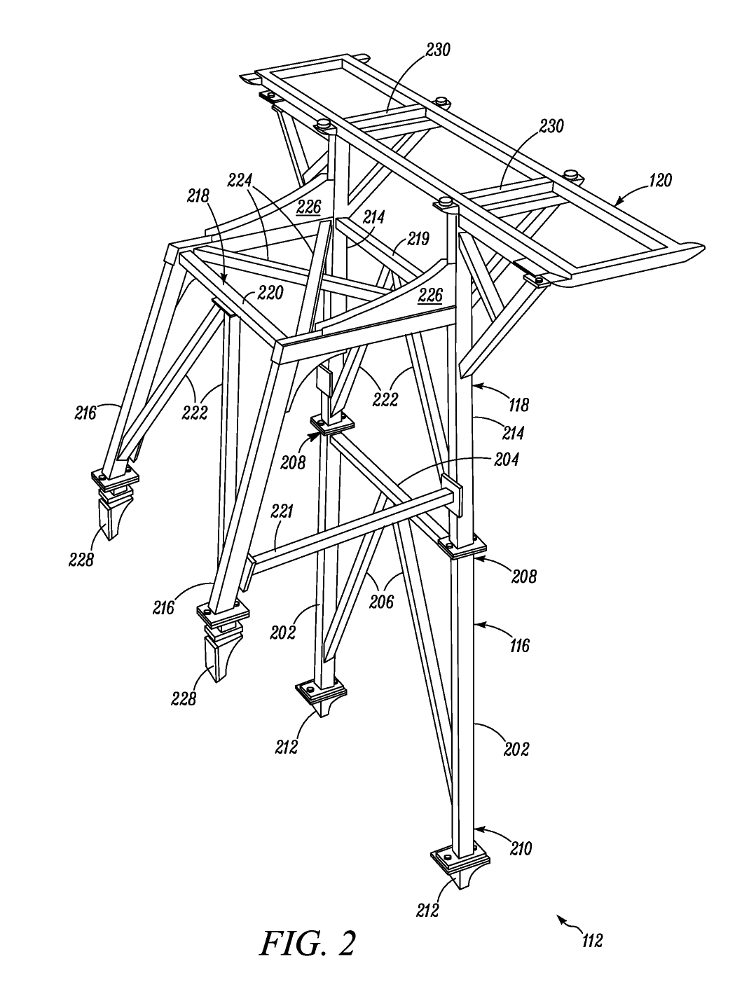

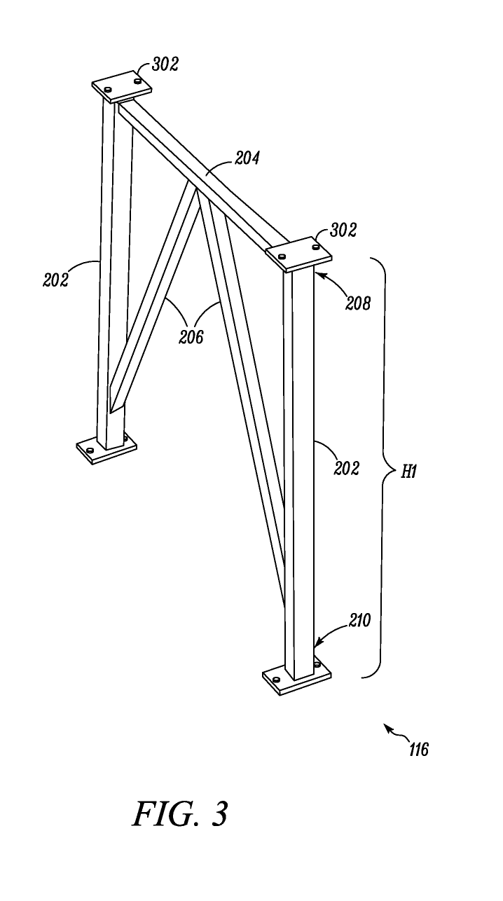

As shown in FIGS. 2, 3 and 6, the bottom support structure 116 includes a pair of primary front legs 202. Furthermore, the pair of primary front legs 202 may be of a first length H1. In one embodiment, the bottom support structure 116 may include a horizontal support member 204 and a pair of angular support members 206. The horizontal support member 204 may be rigidly connected to a top portion 208 of the pair of primary front legs 202. The pair of angular support members 206 may be rigidly connected from the horizontal support member 204 to a bottom portion 210 of the pair of primary front legs 202 of the bottom support structure 116. The horizontal support member 204 and the pair of angular support members 206 provide support and rigidity to the bottom support structure 116.

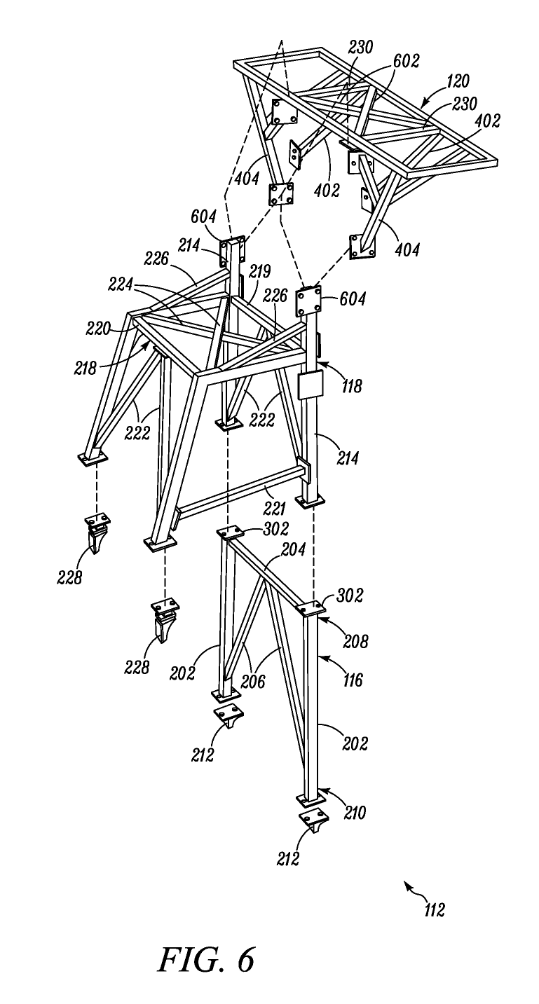

As shown in FIGS. 2 and 6, a pair of front mount elements 212 may be coupled to the pair of primary front legs 202. The pair of front mount elements 212 may facilitate in mounting the bottom support structure 116 on the bumper 104 of the machine 100 as illustrated in FIG. 1. In one embodiment, the pair of front mount elements 212 may be welded to the bumper 104 of the machine 100.

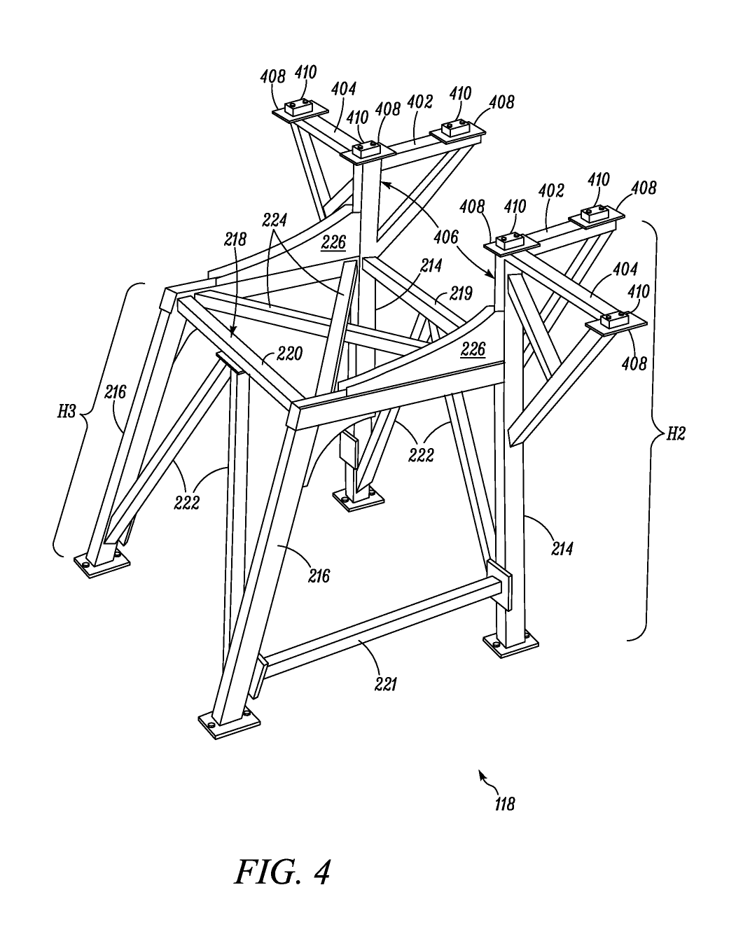

Further, the bottom support structure 116 may be coupled to the mid support structure 118 at mounting plates 302. The mounting plates 302 may have a plurality of holes for bolting the mid support structure 118 to the bottom support structure 116. FIG. 4 illustrates the mid support structure 118. The mid support structure 118 includes a pair of secondary front legs 214 coupled to the pair of primary front legs 202 of the bottom support structure 116. The coupling between the pair of primary and secondary front legs 202, 214 may be provided by bolting, riveting, welding, or any combination thereof. Moreover, any similar coupling mechanism may be used to couple the pair of primary and secondary front legs 202, 214 of the mounting structure 112.

The secondary front legs 214 may be of a second length H2. The mid support structure 118 further includes a pair of angled rear legs 216 rigidly connected to the pair of secondary front legs 214 by a deck 218. The deck 218 may include a box like structure made up of a front member 219, a rear member 220 and two side members. The pair of front legs 214 is attached to the front member 219 of the deck 218, while the pair of angled rear legs 216 are connected to the rear member 220 of the deck 218. The pair of angled rear legs 216 may be of a third length H3. In one embodiment, the second length H2 of the pair of secondary front legs 214 may be greater than the third length H3 of the pair of angled rear legs 216, such that the pair of secondary front legs 214 may extend above the deck 218.

A person of ordinary skill in the art will appreciate that the fixed lengths H1, H2 and/or H3 may be predetermined according to a variety of factors, for example, dimensions of machine 100 on which the mounting structure 112 will be mounted, height of overhead wires, and the like. Also, a ratio between any combination of the fixed lengths H1, H2, and/or H3 may be chosen in order to optimize on rigidity and support provided by the mounting structure 112.

As shown in FIGS. 2, 4 and 6, the mid support structure 118 may include a crossbar 221 and a pair of angular support members 222. The crossbar 221 may be rigidly connected or bolted between one of the pair of secondary front legs 214 and the corresponding one of the pair of angled rear legs 216. The pair of angular support members 222 may be rigidly connected from the deck 218 to the pair of secondary front legs 214 or the pair of angled rear legs 216. Hence, the pair of angular support members 222 may be located on opposite sides as shown in FIGS. 2, 4 and 6.

The mid support structure 118 may further include a pair of cross members 224 rigidly connected to the deck 218. Further, in one embodiment, a pair of angled support members 226 may be rigidly connected between the deck 218 and the pair of secondary front legs 214. The angled support members 226 may be located on opposite sides of the deck 218 and may provide rigidity to the mid support structure 118 of the mounting structure 112.

As shown in FIGS. 2 and 6, the mounting structure 112 may include a pair of rear mount elements 228 coupled to the pair of angled rear legs 216. The pair of rear mount elements 228 may be welded to the frame 106. The pair of rear mount elements 228 may facilitate in mounting the mid support structure 118 on a frame 106 of the machine 100.

In one embodiment as shown in FIG. 4, the mid support structure 118 may include a first and second pair of front and side extended support arms 402, 404. The first and second pair of front and side extended support arms 402, 404 may be rigidly connected to a top portion 406 of the pair of secondary front legs 214. Alternatively, as shown in FIG. 6, the top platform 120 may include the first and second pair of front and side extended support arms 402, 404. In this situation, the first and second pair of front and side extended support arms 402, 404 may be coupled to the pair of secondary front legs 214 of the mid support structure 118. The first pair of front extended support arms 402 may be orthogonal to the second pair of side extended support arms 404.

Mounting plates 408 may be provided on the top portion 406 of the pair of secondary front legs 214, and on the first and second pair of front and side extended support arms 402, 404. Corresponding mounting plates 502 may be provided on the top platform 120 so that the mid support structure 118 may be coupled to the top platform 120 by bolting. In one embodiment, other coupling methods such as riveting, welding, or any combination thereof may also be used.

In another embodiment, as shown in FIG. 4, the mounting structure 112 may also include a plurality of spacers 410 fitted on the mounting plates 408. The spacers 410 may include a bar, a block, and the like. The spacers 410 are placed between the top platform 120 and the top portion 406 of the secondary front legs 214 of the mid support structure 118. The spacers 410 may facilitate in adjusting a height of the mounting structure 112, to allow the pantograph 114 mounted on the top platform 120 make electrical contact with an overhead line or catenary of a power distribution system. In one embodiment, as shown in FIG. 4, the spacers 410 may include a plurality of holes for bolting the top platform 120 to the mid support structure 118.

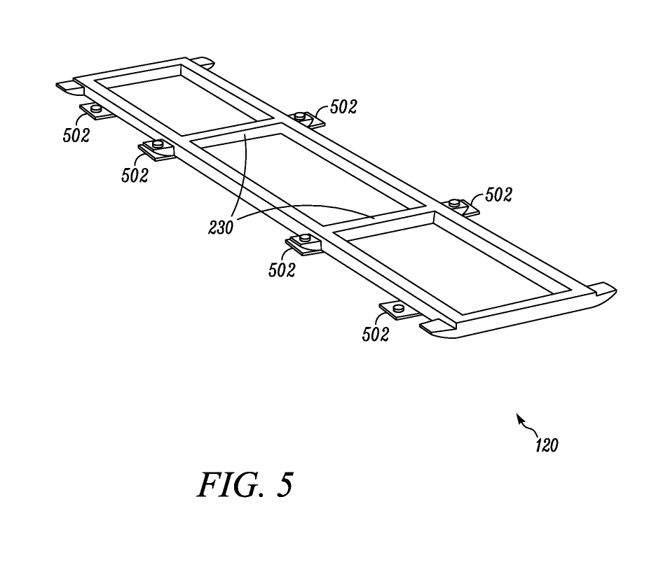

As shown in FIGS. 2, 5 and 6, the top platform 120 may include a plurality of horizontal members 230. In an embodiment as shown in FIG. 6, the top platform may include a cross member 602. Further, in yet another embodiment, mounting plates 604 shown in FIG. 6 may have a plurality of holes for bolting the top platform 120 at different vertical heights, thereby facilitating height adjustment. Alternatively, a length of the mounting plate 604 may be altered so as to allow a variation in height of the mounting structure 112.

The pantographs 114 may be mounted on the top platform 120. In another embodiment, rubber shock mounts or iso-mounts may be provided on the top platform 120 for mounting the pantographs 114.

### Industrial Applicability

The above described mounting structure 112 may be used to mount the pantographs 114 on the machine 100. Generally, the pantographs 114 are mounted on the machine 100, in order to make electrical contact with a power distribution system such as the overhead electric lines or catenary. The pantograph 114 may be used to tap electricity from the electric line and power the machine 100, for example, heavy locomotives, trains, trams, trucks, and the like.

The pantographs 114 allow more power to be transmitted to a drive train of the machine 100 while the machine 100 is heavily loaded. For example, a mining truck may require a large amount of energy, while carrying a load uphill. This energy may be transferred via the pantographs 114. The mounting structure 112 described above, has a modular design including the bottom support structure 116, the mid support structure 118, and the top platform 120. The modularity of the mounting structure 112 may allow easy shipment and also easy assembly at a supplier site. Hence, the modularity allows for ease of manufacture and transport of the mounting structure 112. The mounting structure 112 may have a hollow construction, thereby facilitating in a light weight design.

At step 702, the bottom support structure 116 having the pair of primary front legs 202 of the first length H1 is coupled to the pair of front mount elements 212. The pair of front mount elements 212 may be welded to the bumper 104 of the machine 100. In one embodiment, the coupling may be provided by bolting. At step 704, the mid support structure 118 is coupled to the bottom support structure 116 and the pair of rear mount elements 228. The pair of rear mount elements 228 may be welded to the frame 106 of the machine. In one embodiment, the mid support structure 118 may be bolted to the bottom support structure 116. The mid support structure 118 may include the pair of secondary front legs 214 of the second length H2. The pair of secondary front legs 214 is coupled to the pair of primary front legs 202, thereby coupling the mid support structure 118 and the bottom support structure 116. The pair of primary and secondary front legs 202, 214 may be coupled by bolting, riveting, welding, and/or any other method known in the art. The mid support structure 118 may further include the pair of angled rear legs 216 of the third length H3 rigidly connected to the pair of secondary front legs 214 by the deck 218. In one embodiment, the second length H2 may be greater than the third length H3, such that the pair of secondary front legs 214 extend above the deck 218. The mid support structure 118 may further include the first and second pair of front and side extended support arms 402, 404 rigidly connected to the top portion 406 of the pair of secondary front legs 214.

Subsequently, the pantographs 114 may be assembled on the top platform 120. At step 706, the top platform 120 assembled with the pantographs 114 is coupled to the mid support structure 118. The mounting structure 112 may additionally include other components and/or supporting members, without deviating from the scope of the disclosure.

In another embodiment, the plurality of spacers 410 may be provided between the top platform 120 and the top portion 406 of the secondary front legs 214 of the mid support structure 118. The spacers may facilitate in adjusting the height of the mounting structure 112, to allow the pantograph 114 mounted on the top platform 120 to make electrical contact with an overhead line or catenary of a power distribution system. Additionally, the design of the mounting structure 112 described herein may provide an optimized robust structure. As shown in FIG. 1, the mounting structure 112 may have an overall angled configuration which is forward extending. The angled configuration may facilitate in easy assembly of the mounting structure 112 on the machine 100 having the canopy 108. Moreover, the design of the mounting structure 112 may provide easy visibility to the operator, without causing interference with other structures of the machine 100. It should be understood that all mating surfaces such as the mounting plates 302, 408, 502, 604, faces of the front and rear mount elements 212, 228, the crossbar 221 and the spacers 410 may be cleaned to facilitate well bolted joints and proper grounding.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting structure for one or more pantographs comprising:
a bottom support structure including a pair of primary front legs of a first length;
a mid support structure including:
a pair of secondary front legs of a second length, the pair of secondary front legs coupled to the pair of primary front legs;
a pair of angled rear legs of a third length rigidly connected to the pair of secondary front legs by a deck, wherein the second length is greater than the third length such that the pair of secondary front legs extend above the deck; and
a first and second pair of front and side extended support arms, rigidly connected to a top portion of the pair of secondary front legs; and
a top platform coupled to the mid support structure, the top platform configured to mount the one or more pantographs.

2. The mounting structure of claim 1, wherein the bottom support structure further includes:
a horizontal support member rigidly connected to a top portion of the pair of primary front legs; and
a pair of angular support members rigidly connected from the horizontal support member to a bottom portion of the pair of primary front legs.

3. The mounting structure of claim 1, wherein the mid support structure further includes:
a crossbar rigidly connected between one of the pair of secondary front legs and the corresponding one of the pair of angled rear legs;
a pair of angular support members rigidly connected from the deck to the pair of the secondary front legs and the pair of angled rear legs; and
a pair of cross members rigidly connected to the deck.

4. The mounting structure of claim 1, wherein the pair of primary and secondary front legs are coupled by at least one of bolting, riveting, and welding.

5. The mounting structure of claim 1 further including a pair of front mount elements coupled to the pair of primary front legs, the pair of front mount elements configured to mount the bottom support structure on a bumper of a machine.

6. The mounting structure of claim 1 further including a pair of rear mount elements coupled to the pair of angled rear legs, the pair of rear mount elements configured to mount the mid support structure on a frame of a machine.

7. The mounting structure of claim 1 further including a pair of angled support members rigidly connected between the deck and the pair of secondary front legs.

8. The mounting structure of claim 1 further including a plurality of spacers placed between the top platform and a top portion of the pair of secondary front legs of the mid support structure, the plurality of spacers configured to adjust a height of the mounting structure.

9. A method comprising:
coupling a bottom support structure to a pair of front mount elements, the bottom support structure including a pair of primary front legs of a first length;
coupling a mid support structure to the bottom support structure and a pair of rear mount elements, the mid support structure including:
a pair of secondary front legs of a second length, the pair of secondary front legs coupled to the pair of primary front legs;
a pair of angled rear legs of a third length rigidly connected to the pair of secondary front legs by a deck, wherein the second length is greater than the third length such that the pair of secondary front legs extend above the deck; and
a first and second pair of front and side extended support arms, rigidly connected to a top portion of the pair of secondary front legs; and
coupling a top platform assembled with one or more pantographs to the mid support structure.

10. The method of claim 9, wherein the coupling is provided by at least one of bolting, riveting, and welding.

11. The method of claim 9 further including coupling the pair of front mount on a bumper of a machine.

12. The method of claim 9 further including coupling a pair of rear mount elements on a frame of a machine.

13. The method of claim 9 further including providing a plurality of spacers between the top platform and a top portion of the pair of secondary front legs of the mid support structure, the plurality of spacers configured to adjust a height of the mounting structure.

14. A mounting structure for one or more pantographs comprising:
a bottom support structure including a pair of primary front legs of a first length;
a mid support structure including:
a pair of secondary front legs of a second length, the pair of secondary front legs coupled to the pair of primary front legs; and
a pair of angled rear legs of a third length rigidly connected to the pair of secondary front legs by a deck, wherein the second length is greater than the third length such that the pair of secondary front legs extend above the deck; and
a top platform coupled to the mid support structure, the top platform including a first and second pair of front and side extended support arms coupled to the pair of secondary front legs.

15. The mounting structure of claim 14, wherein the bottom support structure further includes:
a horizontal support member rigidly connected to a top portion of the pair of primary front legs; and
a pair of angular support members rigidly connected from the horizontal support member to a bottom portion of the pair of primary front legs.

16. The mounting structure of claim 14, wherein the mid support structure further includes:
a crossbar rigidly connected between one of the pair of secondary front legs and the corresponding one of the pair of angled rear legs;
a pair of angular support members rigidly connected from the deck to the pair of the secondary front legs and the pair of angled rear legs; and
a pair of cross members rigidly connected to the deck.

17. The mounting structure of claim 14 further including a pair of front mount elements coupled to the pair of primary front legs, the pair of front mount elements configured to mount the bottom support structure on a bumper of a machine.

18. The mounting structure of claim 14 further including a pair of rear mount elements coupled to the pair of angled rear legs, the pair of rear mount elements configured to mount the mid support structure on a frame of a machine.

19. The mounting structure of claim 14 further including a pair of angled support members rigidly connected between the deck and the pair of secondary front legs.

20. The mounting structure of claim 14 further including a plurality of spacers placed between the top platform and a top portion of the pair of secondary front legs, the plurality of spacers configured to adjust a height of the mounting structure.
